(19) United States
(12) Patent Application Publication
(10) Pub. No.: US 2011/0275475 A1
(43) Pub. Date: Nov. 10, 2011

(54) MULTI-GEAR TRANSMISSION FOR BICYCLES

(76) Inventor: Eckhardt Eisenbeil, Augsburg (DE)

(21) Appl. No.: 13/132,623

(22) PCT Filed: Dec. 2, 2009
(86) PCT No.: PCT/EP2009/066259

§ 371 Date: Jul. 26, 2011

(30) Foreign Application Priority Data
Dec. 6, 2008 (DE) 10 2008 060 856.4

(51) Int. Cl. B62M 11/18; F16H 3/46

(52) U.S. Cl. 475/296

(57) ABSTRACT

The invention relates to a multi-gear transmission for bicycles, comprising a plurality of crown gear transmissions (a, b) for providing different transmission ratios, with at least two crown gears (3, 9, 61a, 62a, 63a, 61b, 62b, 62c), a shifting device (2; 2a, 2b, 722) for selectively connecting the crown gears (3, 9, 61a, 62a, 63a, 61b, 62b, 62c) to fixed and/or rotating drive elements (1, 10, 12, 31, 100) and a plurality of pinions (4a, 4b) disposed between the crown gears (3, 9, 61a, 62a, 63a, 61b, 62b, 62c), each of said pinions being mounted on a pinion carrier (5a, 5b) rotatable about axes (51a, 51b) that are perpendicular the rotating axis of the crown gears (3, 9, 61a, 62a, 63a, 61b, 62b, 62c) and being engaged with the crown gears (3, 9, 61a, 62a, 63a, 61b, 62b, 62c).

The invention relates to a multi-gear transmission for bicycles comprising at least two crown-gear transmissions for providing different transmission ratios.

Multiple-gear transmissions for bicycles are already known which present one or a plurality of planet gears each with a sun gear, a planet carrier fitted with one-stage or multi-stage planet gears, and an annulus gear. In these transmissions, the rotating axes of the drive elements are disposed parallel to the hub axle. In the case of this conventional planetary gearing, the number of teeth of a wheel is obtained, with predefined spatial position of the axes, from the numbers of teeth of the other two participating gearwheels. Thus, in the case of multi-stage planet gears, which are engaged with more than one sun gear and more than one annulus gear, there is no longer independence of the numbers of teeth due to the spatial establishment of the planetary axes. The result of this is that, in the case of given installation dimensions, the number of ergonomically reasonable gear ratios and step graduations is limited.

This restriction can be greatly reduced by using crown-gear transmissions. A great advantage of crown-gear transmissions is the axial pinion freedom. This means, in the case of a cylindrical pinion, that the pinion is capable of moving freely in the axial direction over the gearing, or a pinion can mesh with several freely rotating crown gears. An additional advantage is the achievement of large gear ratios in one stage with an efficiency which is similar to that of a spur or bevel gear. In contrast to the bevel gear, no axial forces are generated in the process, which worsen the efficiency due to increased bearing friction.

In the context of a crown-gear transmission which consists of two crown gears and a cylindrical straight or slanted spur wheel located in between, the diameters of the crown gears and thus the numbers of teeth of the crown gears can be varied independently of each other within relatively large ranges, without in the process changing the spatially predetermined position of the axes.

Numerous inventions in the field of bicycle transmissions are known, which contain either true crown-gear transmissions or transmissions whose operation is equivalent to that of a crown-gear transmission. The most frequently encountered configurations are those in which the drive occurs by means of the bottom bracket, and the output drives the back wheel hub. The drive and output thus does not occur on the same axis. Each one of these transmissions consists of several concentrically disposed rows of teeth and one or a plurality of pinions.

These types of transmissions can be divided into two categories:

### Category A:

The implementation of different gears occurs by the active participation of the pinion

### Category B:

The implementation of different gears occurs by the active participation of the crown gears

Category A can be further divided into two subcategories:

### Category A1:

Each pinion engages permanently with the corresponding crown gear. Because each individual pinion can selectively be connected non-rotatably via a corresponding shifting mechanism to the pinion axis, different gear ratios are achieved. As a result of the transferred torque, the pinion axis now acts as shaft. Because only one pinion is used for the torque transfer, both the crown gear and the pinion must be dimensioned appropriately. For this purpose, a larger weight must be accepted in general. Inventions of this type are described in WO 2007 015609A1 or US 2004/0043852 A1.

### Category A2:

The pinions do not engage at all or only partially with a crown gear during the shifting process. The greatest disadvantage of these transmissions is the need to interrupt the torque transfer. This behavior is particularly undesirable in difficult terrains. Inventions of this type are described in WO 2004 042252A1, U.S. Pat. No. 6,155,127, US000007434489B1 or U.S. Pat. No. 5,005,438.

Transmissions of category B contain a plurality of concentric crown gears which can be moved away from each other independently in the axial direction, and are caused to engage with a pinion.

In the process, one of the crown gears is moved axially towards the pinion by a shifting mechanism, and caused to engage. The different transmissions result from the diameter difference between the crown gears. By means of an additional pinion stepping, the corresponding gear transmission can be finely tuned. Inventions of this type are described in WO2004/028891 A1 or U.S. Pat. No. 6,827,362 B2.

The problem of the invention is, in the case of a multi-gear transmission for bicycles, to accommodate the maximum number of possible gear ratios in the smallest possible construction space.

This problem is solved according to the invention by a multi-gear transmission with the characteristics of claim 1 or 20. Advantageous embodiments and advantageous variants of the invention are the subject matter of the dependent claims.

The multi-gear transmission according to the invention contains at least two crown-gear transmissions for providing different transmission ratios, with at least two crown gears, a shifting device for selectively connecting the crown gears to fixed and/or rotating drive elements and a plurality of pinions disposed between the crown gears, each of said pinions being mounted on a pinion carrier rotatable about axes that are perpendicular to the rotating axis of the crown gears and being engaged with the crown gears. The two crown-gear transmissions present a common rotating axis, and each pinion of the pinion carrier(s) engages permanently with at least two crown gears. Here, the multi-gear transmission can be accommodated in a hub shell or a bottom bracket shell.

Additional characteristics and advantages of the invention result from the following description of several embodiment examples in reference to the drawing. The figures show:

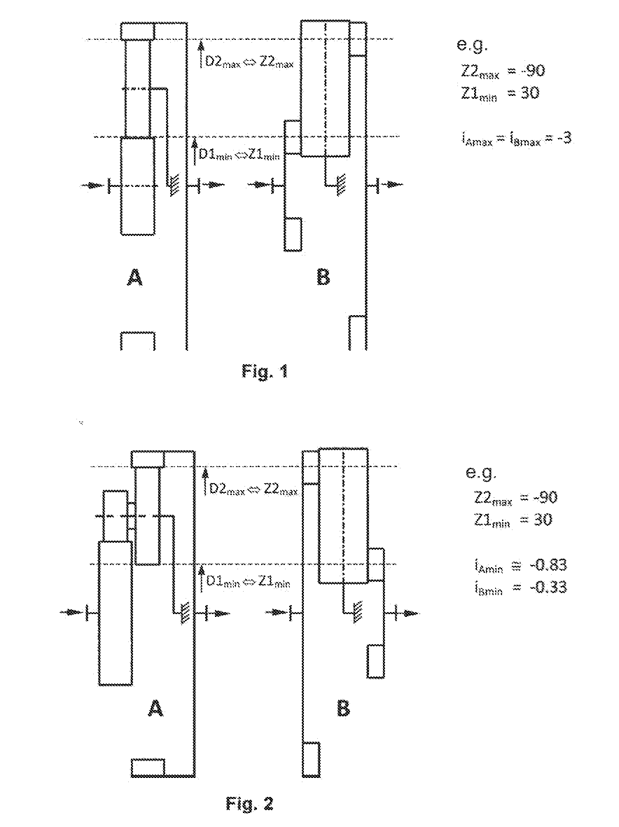

FIG. 1, a schematic diagram of a planetary and crown-gear transmission with maximum gear ratio;

FIG. 2, a schematic diagram of a planetary and crown-gear transmission with minimum gear ratio;

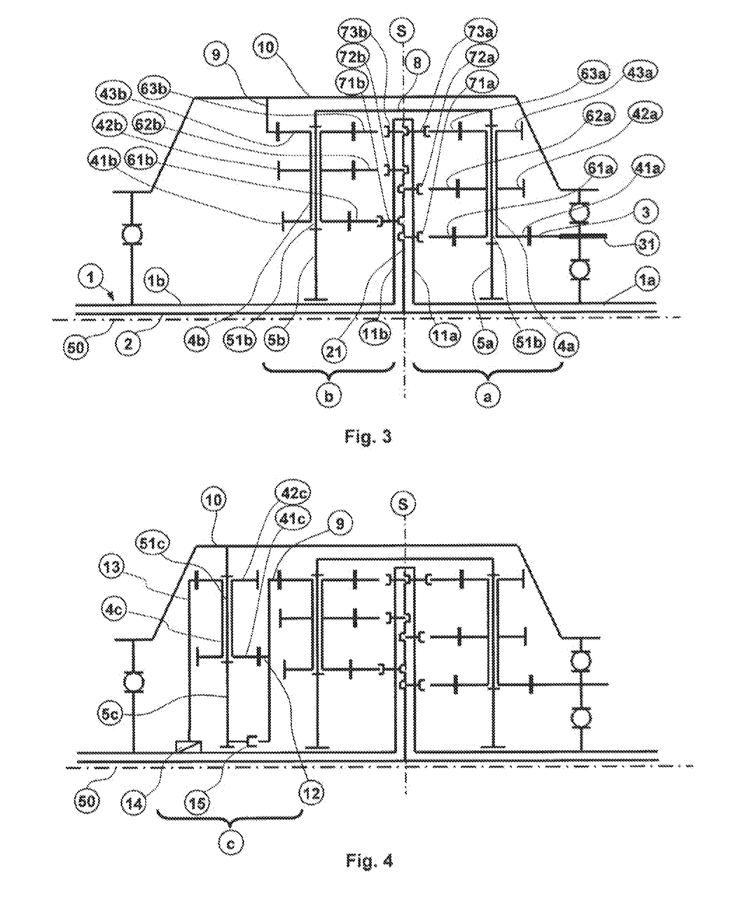

FIG. 3, a schematic diagram of a 9-gear coupling mechanism;

FIG. 4, a schematic diagram of an 18-gear transmission with a coupling mechanism;

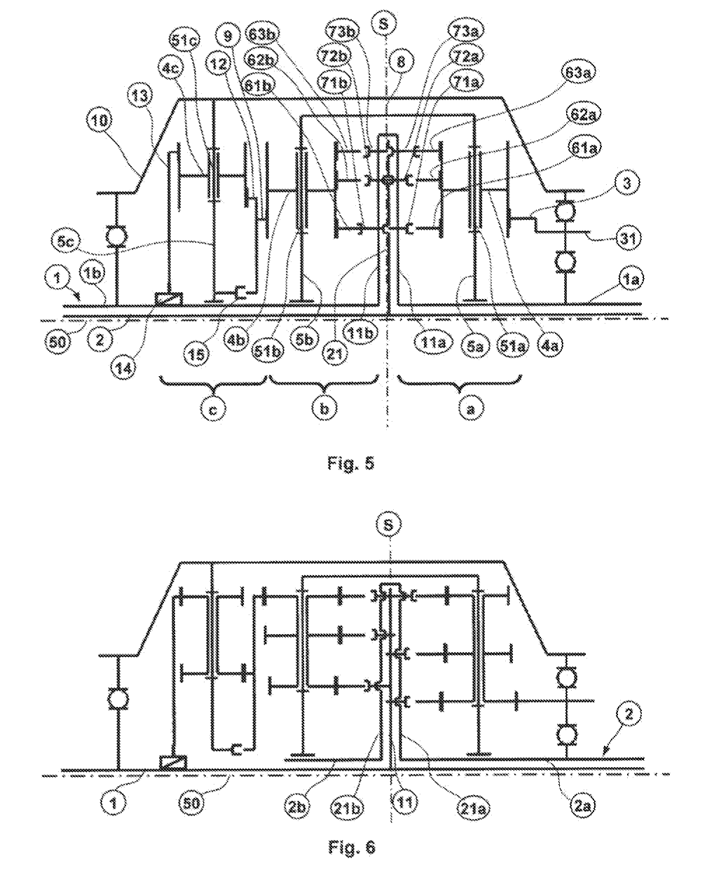

FIG. 5, a schematic diagram of a 14-gear transmission in a shifting variant 1,

FIG. 6, a schematic diagram of an 18-gear transmission in a shifting variant 2,

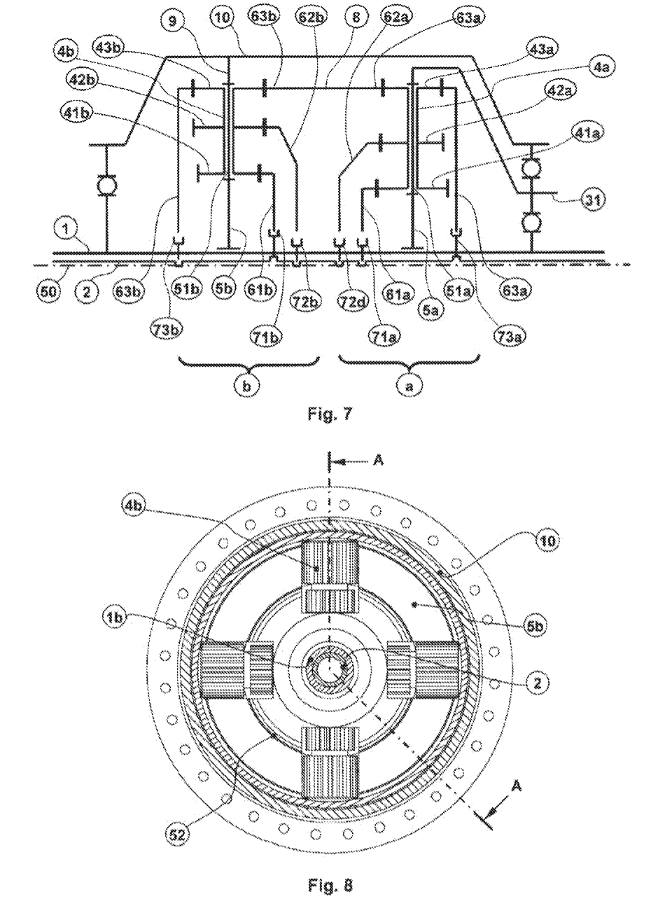

FIG. 7, a schematic diagram of a 9-gear transmission in a shifting variant 3 with the drive above the pinion carrier;

FIG. 8, a simplified transmission cross section;

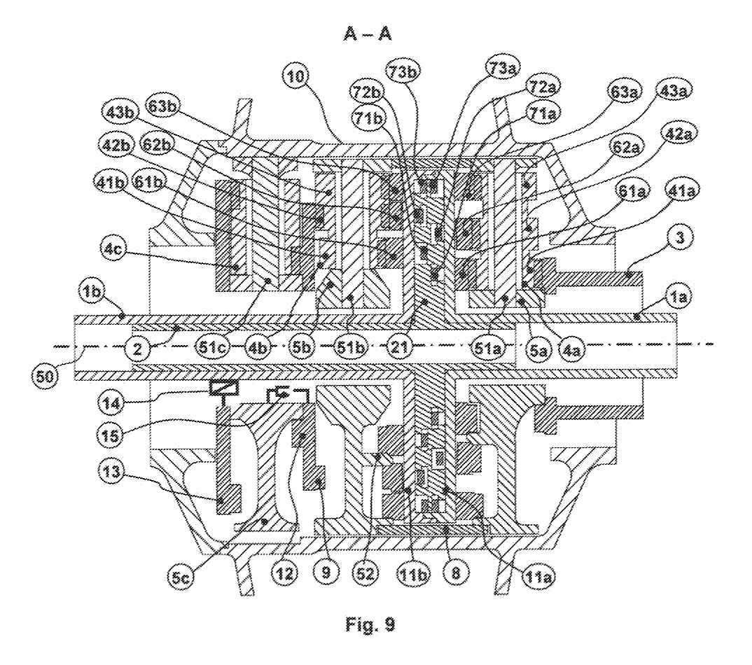

FIG. 9, a simplified 18-gear transmission longitudinal section;

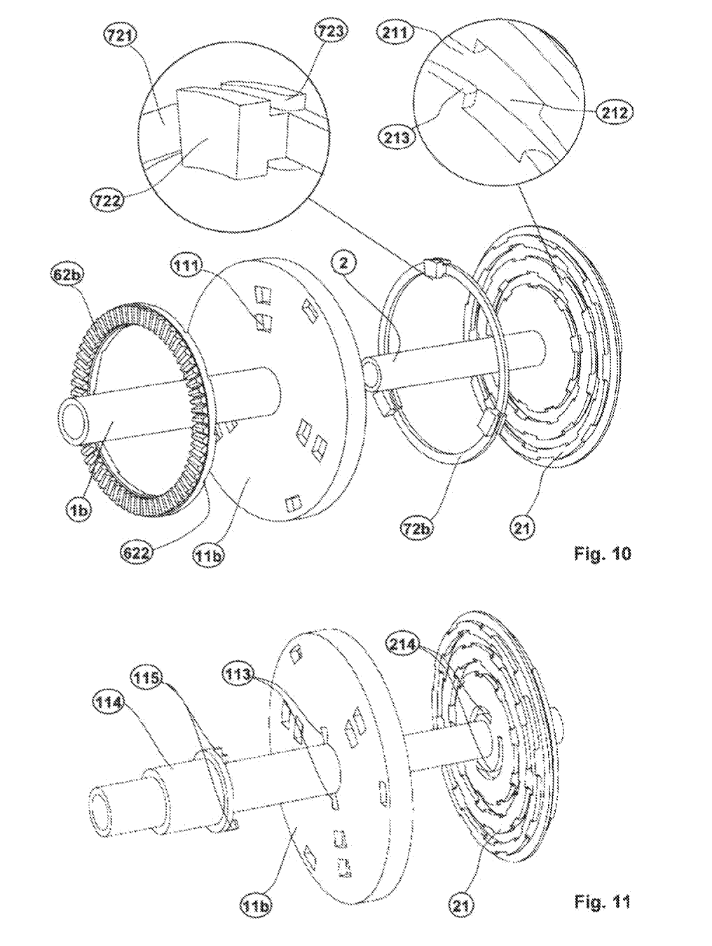

FIG. 10, an exploded view of the shifting variant 1;

FIG. 11, an axial control of a coupling ring;

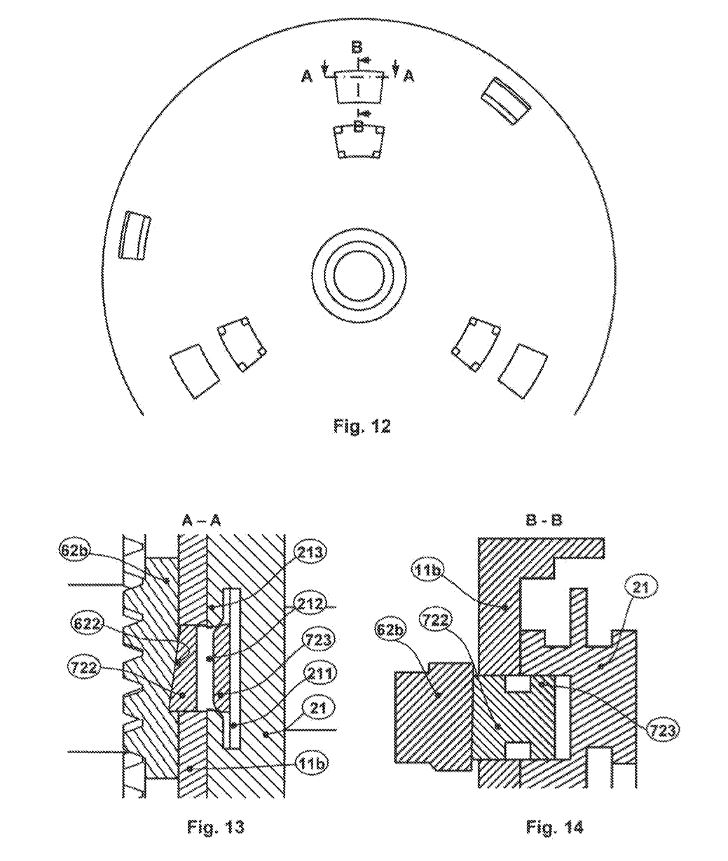

FIGS. 12-14, a section profile and partial sections for the shifting variant 1;

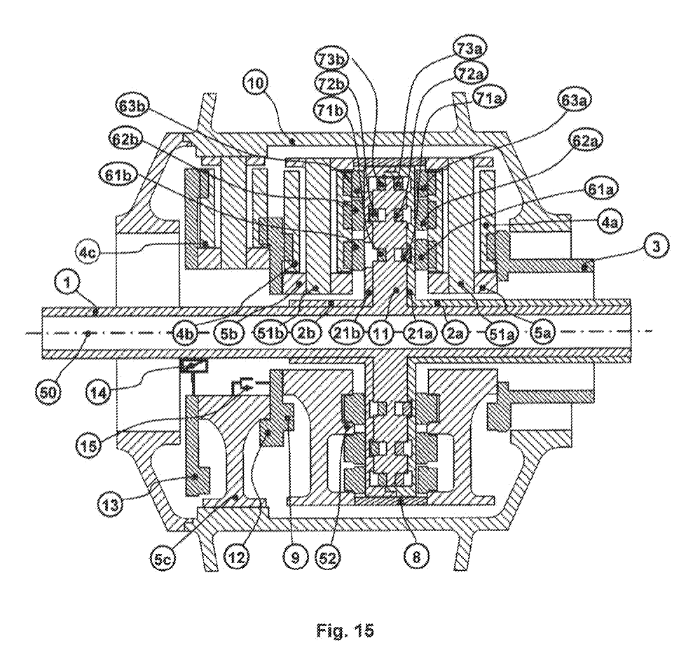

FIG. 15, a simplified 14-gear drive transmission longitudinal section;

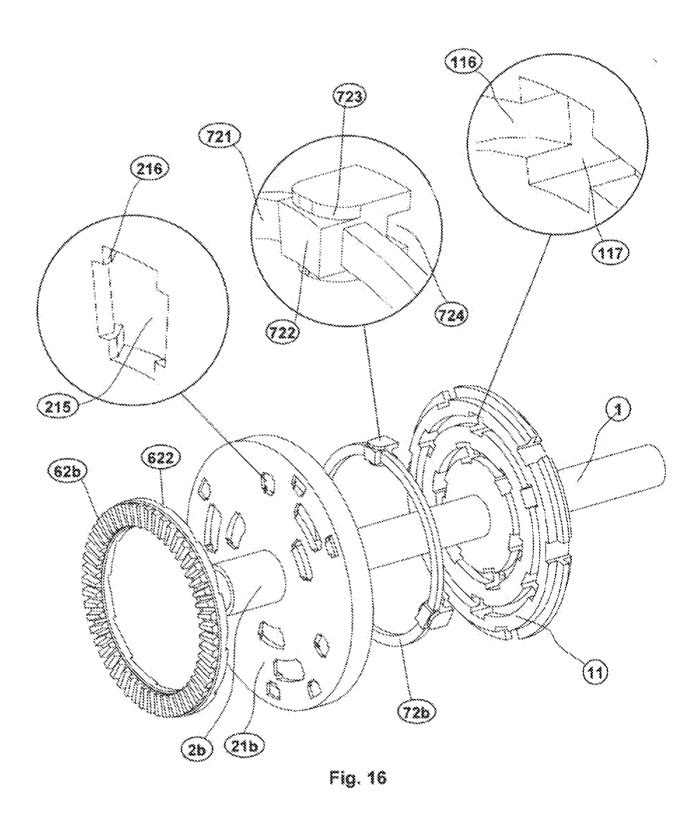

FIG. 16, an exploded view of the shifting variant 2;

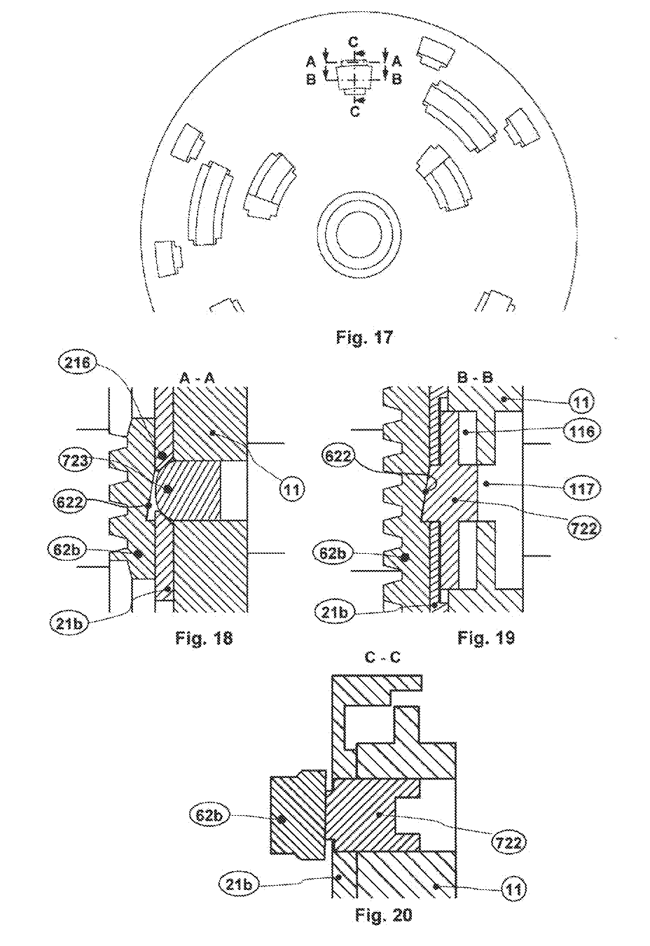

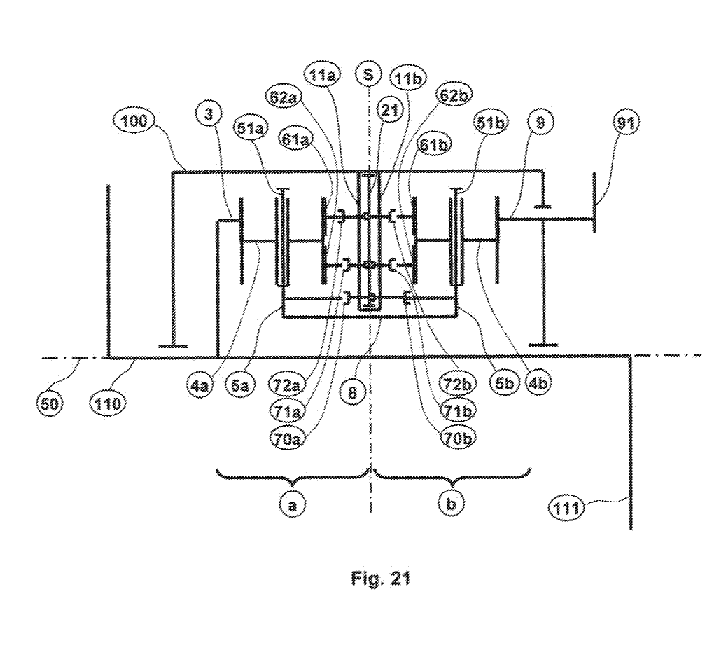

FIG. 17 to FIG. 20, a section profile and partial sections for the shifting variant 2;

FIG. 21, a schematic diagram of a 7-gear transmission for the bottom bracket;

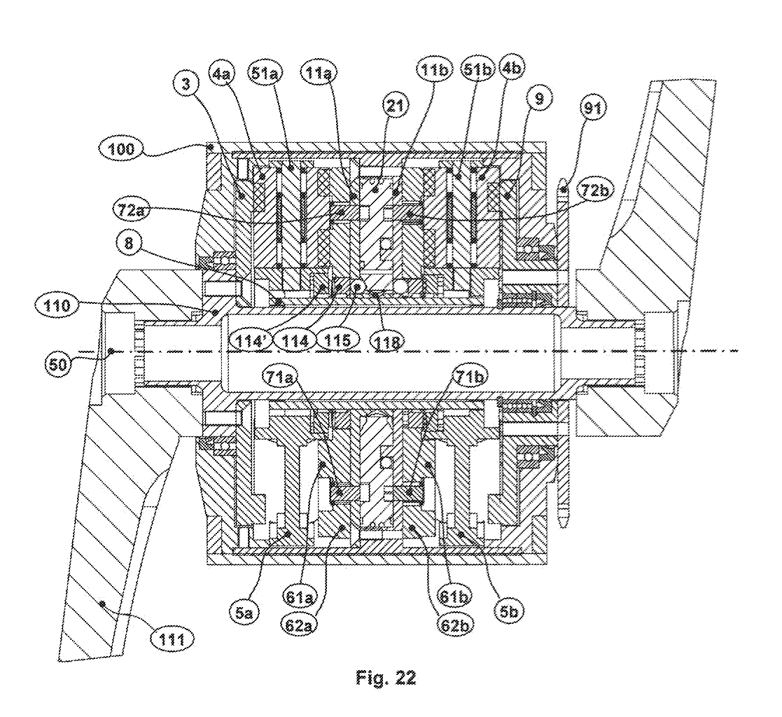

FIG. 22, a 7-gear transmission longitudinal section for the bottom bracket;

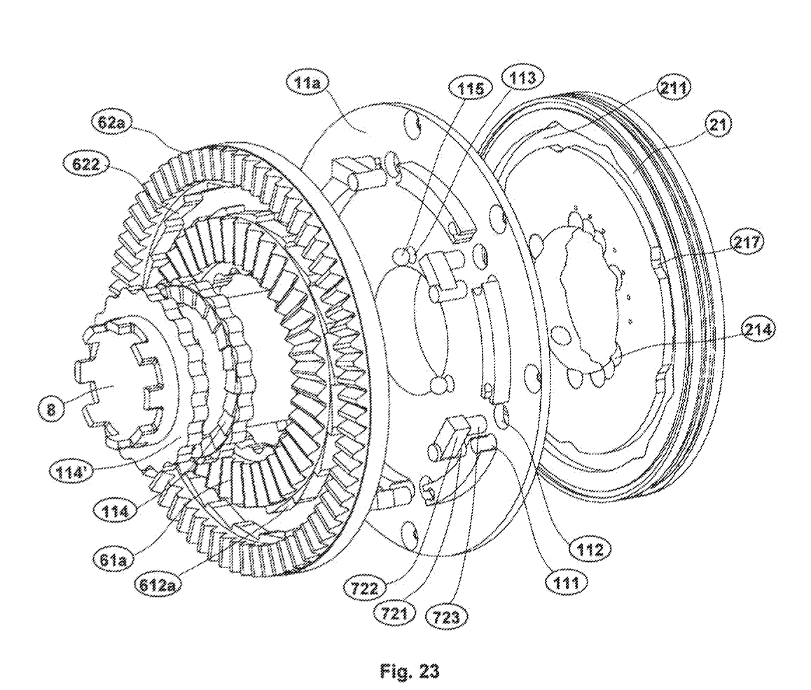

FIG. 23, an exploded view of the shifting variant for the bottom bracket;

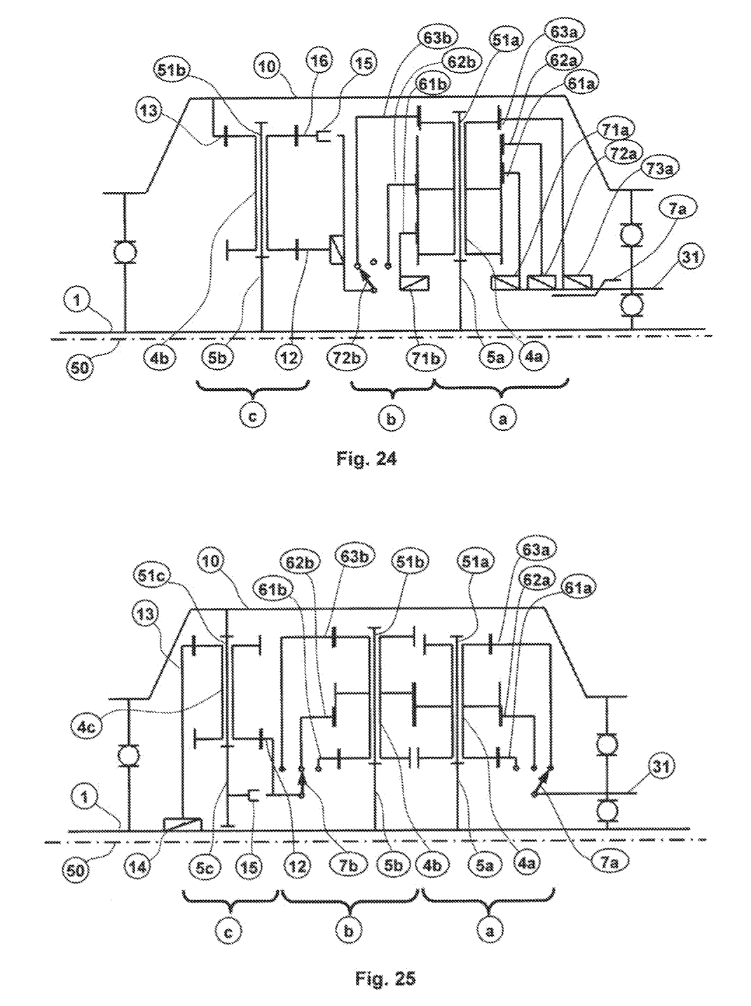

FIG. 24, a schematic diagram of a multi-gear transmission with two minus crown-gear transmissions, and

FIG. 25, a schematic diagram of an 18-gear transmission with three uncoupled crown-gear transmissions.

FIGS. 1 and 2 show a comparison of a planetary gearing (Embodiment A) and a crown-gear transmission (Embodiment B), where both transmissions are designed as minus gearing. FIG. 1 shows the dimension of the gear elements corresponding to the maximum gear ratio, and FIG. 2 corresponding to the minimum gear ratio. It is apparent here that, in the case of the example numbers of teeth (Z2ₘₐₓ=−90, Z1ₘᵢₙ=30), the possible gear ratio range of the crown-gear transmission with i_{B}=−0.33 . . . −3 is substantially greater than that of the planetary gearing with i_{A}=−0.83 . . . −3. Thus, the choice of reasonable steppings for a given construction space increases. In addition, due to the width offset of the crown gears, the possibility exists of varying the diameter of the crown gear within an interval, with the number of teeth remaining identical, so that the diametral broadening of the crown gear does not necessarily turn out to be a restriction. This allows an enlargement of the structural clearance in the case of a concentric arrangement of several crown gears. Due to this stepping of the pinion in the area of the tooth engagement, it is also possible to influence the transmission ratio. However, this is only reasonable in a small range, to keep the axial dimension of the crown-gear transmission, i.e., along the hub axle, small. The disadvantage of larger dimensions in the axial direction (along the rotating axis) of the crown-gear transmission in comparison to planetary gearing is made less absolute in the case of the drive-side or output-side use of a plurality of crown gears disposed concentrically to the rotating axis, with corresponding shifting device.

The operation of the multi-gear transmission according to the invention is explained in reference to a multi-gear transmission shown in FIG. 3 as a schematic diagram and in FIG. 9 in a cross-sectional representation. In this embodiment, the multi-gear transmission is integrated in a hub shell 10, which is mounted rotatable about a transmission shaft 1 which is rigidly connected to a bicycle frame. In the representation, the bearing, gaskets, screw connections, and other elements that occur in the bicycle gear construction, have largely been omitted, because they are known to someone skilled in the art. The transmission shaft 1, in the embodiment example shown, consists of two hollow shaft halves 1a and 1b and two axle disks 11a and 11b which are mutually connected in a plane S. The two axle disks 11a and 11b are designed advantageously to form a single piece with the respective hollow shaft halves 1a or 1b. The two hollow shaft halves 1a and 1b are connected to each other at the axle disks 11a and 11b with positive locking connection, bending resistance, and in a rotationally fixed manner.

Within the transmission shaft 1, a shifting device is accommodated with a shifting sleeve 2 disposed in the shaft halves 1a and 1b, with a shifting disk 21 disposed within the axle disks 11a and 11b, and with clutch elements 71a, 72a, 73a or 71b, 72b and 73b. The shifting disk 21 is advantageously designed to form a single piece with the shifting sleeve 2. On the two outer sides of the axle disks 11a and 11b, in each case three crown gears 61a, 62a, 63a or 61b, 62b and 63b are disposed, which are concentric to the transmission shaft 1, and present different diameters. By means of the shifting device, the clutch elements 71a, 72a, 73a or 71b, 72b and 73b can be shifted selectively so that the freewheeling in at least one direction of one of the crown gears 61a, 62a, 63a or 61b, 62b and 63b is prevented. Here, pawls, toothed disks, clamping bodies, or claws can be used as clutch elements.

The crown gears 61a, 62a and 63a disposed on the right in FIGS. 3 and 9 are engaged permanently with three pinion stages 41a, 42a and 43a of several three-stage first pinions 4a which are distributed uniformly in the peripheral direction, and which are mounted on a first pinion carrier 5a—mounted rotatable within the hub shell 10—rotatable about axes 51a which are perpendicular to the rotating axes of the crown gears 61a, 62a and 63a. The crown gears 61b, 62b and 63b disposed on the left are engaged permanently with three pinion stages 41b, 42b and 43c of three three-stage second pinions 4b which are distributed uniformly in the peripheral direction, and which are mounted on a second pinion carrier 5b—mounted rotatable within the hub shell 10—rotatable about axes 51b which are perpendicular to the rotating axis of the crown gears 61b, 62b and 63b. In the embodiment example shown, on the pinion stages 41a, 42a and 43a or 41b, 42b and 43c, four pinions 4a or 4b are mounted on the pinion carriers 5a and 5b in each case, rotatable about axes 51a or 51b disposed in a sunray pattern. As a function of the transferred torque, however, the pinion carriers 5a and 5b can also present another number of axes.

In the embodiment shown in FIG. 3, the gearing 41a of the first three-stage pinion 4a engages with a drive-side crown gear 3, which can be rotated by a driver 31. The pinions 4b are engaged via the pinion stage 43b with an output-side crown gear 9, which is connected to the hub shell 10. The pinions 4a together with the drive-side crown gear 3 and the crown gears 61a, 62a and 63a form a first crown-gear transmission a, while the pinions 4b together with the crown gears 61b, 62b, 63b and the output-side crown gear 9 form a second crown-gear transmission b. The two crown-gear transmissions a and b present a common rotating axis 50, and they are coupled to each other via a connecting sleeve 8 disposed between the pinion carriers 5a and 5b.

The crown-gear transmission a is driven via the pinion stage 41a by the drive crown gear 3. The output occurs by means of the pinion carrier 5a into the connecting sleeve 8. The crown gears 61a, 62a, 63a are permanently engaged with the corresponding pinion stages 41a, 42a, 43a of the pinion 4a. The different transmission ratios are implemented by the fact that the freewheeling of one of the crown gears 61a, 62a or 63a over the corresponding shifting clutch elements 71a, 72a or 73a is prevented. In this case, the coupled crown gear 61a, 62a or 63a is connected in one direction torsion-free to the axle disk 11a. Thus, in the case of a crown-gear transmission with three crown gears, three gear ratios can be implemented.

The crown-gear transmission b functions analogously to the crown-gear transmission a, except that the drive and output elements have been exchanged. This means that the drive occurs via the pinion carrier 5b, and the output via the output-side crown gear 9. The output-side crown gear 9 is connected rigidly to the hub shell 10. Thus, the hub shell 10 is offset in a rotational movement relative to the transmission shaft 1.

The total number of gear ratios is obtained by multiplying the gear ratio possibilities of the individual gears. In the embodiment shown in FIG. 3, 3×3=9 gear ratios, and thus 9 gears would be possible. Here, the gear ratio of the overall transmission results from the interplay of the two crown-gear transmissions a and b. In the present case, six additional gears can theoretically be implemented, if, by additional axial shifting clutching operations, on the one hand, the drive-side crown gear 3 is coupled to the pinion carrier 5a, and, on the other hand, the pinion carrier 5b is coupled to the output gear 9. In each of these couplings, the respective crown-gear transmission is locked in its gear ratio function, resulting in a transmission ratio of 1:1. Thus, theoretically, a total of 3×3+3+3=15 gears would be possible. When using two concentric crown gears per crown-gear transmission, the additional partially direct gears can result in a plurality of reasonable steppings (see Tables 6, 7, 8). In the case of more than two concentric crown gears per crown-gear transmission, the generation of a reasonable gear stepping within the usual construction space is possible only by skipping over gears (see Table 8). Moreover, transmission gears which are implemented by locking out the crown-gear transmission (gear ratio=1) are referred to as partially direct gears.

A doubling of the gear number is possible, if an additional gear stage is connected downstream. The doubling of the gear number can be implemented by a planetary gearing, described, for example, in EP 0 915 800 B1, or by an additional crown-gear transmission c represented in FIG. 4. As a rule, this downstream-connected gear c is designed as transmission gear in such a way that the transmission ratios with and without downstream-connected gear do not overlap. As also apparent from FIG. 9, the crown gear 9, in contrast to the design of FIG. 3, is no longer connected to the hub shell 10, but rigidly connected to an additional crown gear 12. The latter drives one-stage or multi-stage third pinions 4c which are mounted rotatable about the axes 51c of a third pinion carrier 5c which is connected rigidly to the hub shell 10. The third pinions 4c, according to FIG. 4, are engaged via a first pinion stage 41c with the crown gear 12, and braced via a second pinion stage 42c on an additional crown gear 13. This crown gear 13 is connected to the hub axle 1 via a freewheel 14. Via a shifting clutch 15, the crown gear 12 can be connected to the pinion carrier 5c. By bracing the pinion stage 42c on the crown gear 13, the pinion carrier 5c is set into a rotating motion. Due to the rigid connection of pinion carrier 5c and the hub shell 10, the rotation of the pinion carrier 5c is transferred to the hub shell 10. The bracing of the pinion 4c on the crown gear 13 is possible because the crown gear 13 is connected to the transmission shaft 1 designed as a hub axle via the freewheel 14. The freewheel 14 locks, when the shifting clutch 15 is not active, and a load torque is applied to the hub shell 10. If the shifting clutch 15 is activated, the crown gear 12 is connected torsion-free to the pinion carrier 5c which itself is connected torsion-free to the hub shell 10, and thus drives the hub shell 10 without gear ratio. The pinion 4c in this case is locked, and it forces the movement of the pinion carrier 5c onto the crown gear 13. However, since now the freewheel becomes active, no locking of the transmission occurs. The entire crown-gear transmission c can in this case be seen as forming a rigid connection between the crown gear 12 and the hub shell 10. In this case, the behavior of the transmission of FIG. 4 is the same as that of the transmission of FIG. 3. Instead of the described crown gear-pinion carrier coupling, the two crown gears 12 and 13 can also be coupled with the same effect.

A special case of the transmission of FIG. 4 is the case where the crown-gear transmissions a and b present the same numbers of teeth of crown gears and pinions. Of the previously 9 gears, now 3 gears have the transmission ratio 1:1 and are combined into one gear. As a result, the 18-gear transmission of FIG. 4 becomes the 14-gear transmission according to FIG. 5 with the crown-gear transmissions a and b.

FIG. 3 shows a shifting in which the shifting sleeve 2 is located within the transmission shaft 1. This shifting variant is referred to as shifting variant 1 below. An additional shifting variant is produced when the shifting sleeve 2 encloses the transmission shaft 1 (FIGS. 6 and 15). In this case the shifting sleeve 2 consists of the parts 2a and 2b which end in the direction toward the plane S in the shifting disks 21a and 21b. The shifting sleeves 2a and 2b, and the corresponding shifting disks 21a or 21b, in the ideal case, are made from a single piece. However, the two shifting disks 21a and 21b, are connected non-rotatably, but not necessarily with bending resistance, to each other. Between the two shifting disks 21a and 21b, the axle disk 11 is located, which is rigidly connected to the transmission shaft 1. This shifting variant is referred to as shifting variant 2 below.

Alternative to the torque application via the crown gear 3, there is the possibility of driving via the pinion carrier 5a. (FIG. 7). In this case, the connection of the crown-gear transmissions a and b is implemented via coupled crown gears. In the ideal case, this connection consists of a sheath 8, whose ends are designed as crown gears. In order to present additional shifting possibilities, the shifting of the drive of FIG. 7 does not occur as described so far, via shifting disks, but via a hollow camshaft 20 which extends in the transmission shaft 1, and serves to control the ratchet pawls. This shifting possibility is referred to as variant 3, and as such is known in bicycle gear construction.

FIG. 9 represents a simplified possible design of an 18-gear transmission in longitudinal section. The numbering of the components corresponds largely to that of FIG. 3 and FIG. 4. When using three or more than four pinions per pinion carrier, an automatic centering of those crown gears occurs that are engaged with the pinions. In a 4-pinion configuration, a centering with cylindrical recesses 52 of the pinion carrier can occur, as can be seen in the transmission cross section (FIG. 8) or in the transmission longitudinal section (FIG. 9). Alternatively, a ring can be used which is embedded radially in the pinion carrier.

For the radial mounting of the crown gears or the pinion carriers about the hub axle, it is theoretically possible, in the case of an odd number of a plurality of pinions per pinion carrier, to radially mount only one element (crown gear or pinion carrier) of the crown-gear transmission, because a self-centering occurs between crown gear and pinions. The mounting of the pinions on the axes of the pinion carrier can occur either by means of slide bearings or preferably roller bearings. The possible technical realizations of the freewheel, of the axial shifting clutch, and of the downstream connected doubling stage, are largely known to someone skilled in the art, and are represented here only schematically.

The shifting elements participating in the shifting variant 1 are represented in FIG. 10 for the crown-gear transmission b in an exploded view. Within the hollow shaft 1b, the shifting sleeve 2 is located, which is rigidly connected to the shifting disk 21. In the shifting disk 21, concentric T-shaped or L-shaped grooves 211 are incorporated, whose number corresponds to the number of crown gears to be locked. Below, the construction and operation of the shifting are explained using the example of the crown gear 62b to be locked, where corresponding shifting elements are provided for shifting the additional crown gears.

For shifting the crown gear 62b, in a groove 211 of the shifting disk 21, wherein this groove is part of the crown gear 62b, a ratchet ring 72b concentric to the transmission shaft 1 is disposed which in the embodiment shown consists of a ring 721 with shifting element referred to as ratchet pawls 722. The shifting elements are referred to as ratchet pawls 722, even though they do not correspond to the usual conception of a lever that is mounted rotatable about a pivot. The ratchet pawls 722, to provide a freewheel function, are inclined toward the crown gear 62b, and they are set back in the area of the ring 721, so that a shifting tongue 723 results on the inner side. In the non-shifted state, the shifting tongue 723 slides over the groove 211. The walls 213 of the groove 211 are provided with breakouts 212 at defined places. By rotating the shifting disk 21, the shifting tongue 723 reaches these breakouts 212 and is released by the groove 211. Under the force of a spring not shown here, the entire ratchet ring 72b is pressed axially in the direction of the crown gear 62b. The ratchet pawl 722 is guided axially at all times in a passage 111 of the axle disk 11b. In the non-shifted state, the ratchet pawls 722 are inserted completely in the passage 111. In the shifted state, the ratchet pawls 722 protrude in the direction of the crown gear 62b out of the passages 111, and engage with several sawtooth recesses 622 distributed in the peripheral direction on the inner front side of the crown gear 62b. The result is the locking of the crown gear 62b in one direction. This state is represented in the detail sections of FIGS. 13 and 14.

Due to the sawtooth recesses 622 of the crown gear 62b, and the corresponding beveling of the ratchet pawl 722, freewheeling occurs in the other rotational direction, because the ratchet pawl 722 is countersunk in the passage 111 of the axle disk 11b. Both the shifting tongue 723 of the ratchet ring 72b and the groove walls at the breakouts 212 are rounded or provided with a bevel. The result is that, when the shifting disk 21 is turned further, the shifting tongue 723 is moved by the groove wall ends axially in the direction of groove 211, until the shifting tongue 723 is completely in the groove 211. Thus, the ratchet pawl 722 also is also countersunk in the passage 111 of the axle disk, and the crown gear 62b is released.

The use of the ring 721 is not absolutely necessary. It merely guarantees a more uniform load distribution in the case of the use of several ratchet pawls 722. The number of ratchet pawls 722 is limited by the number of gears to be shifted and the peripheral length available. In the case of an 18-gear transmission based on a 9-gear transmission, one must ensure, for example, that, when three ratchet pawls per crown gear are used, nine shifting processes can be carried out within 120°.

The tangential arrangement of the breakouts 212 is determined by the shifting sequence, the position of the axle disk passage 111, and the number of ratchet pawls 722. The arrangement and design of the shifting elements of FIG. 10, in a practical application, must be adapted in such a way that a freewheeling can be ruled out. The procedure is known to someone skilled in the art and not explained further.

In FIG. 11, the possibility is represented to move a coupling ring 114 in the axial direction, by the introduction of grooves 214 into the shifting disk 21. Here, appropriately shaped shifting pins 115 of the coupling ring 114, guided by the passages 113 of the axle disk 11b, engage in the grooves 214 of the shifting disk 21.

FIG. 15 represents a simplified embodiment of a 14-gear transmission in longitudinal section. The transmission contains the shifting variant 2. The numbering of the components corresponds largely to that of FIG. 5 and FIG. 6. The freewheel of the crown gear 13, and the axial shifting clutch 15 are also shown only schematically here.

The operation of the shifting variant 2 is explained in reference to FIG. 16 using the example of the locking crown gear 62 of the crown-gear transmission b. In this variant, the shifting sleeve 2b encloses the transmission shaft 1. The axle disk 11 and transmission shaft 1 are connected rigidly to each other, and manufactured preferably from a single piece. In the axle disk 11, concentric grooves 116 are incorporated, whose number corresponds to the number of the crown gears to be locked. The groove 116 is provided at defined places with recesses 117. In the groove 116, a ratchet ring 72b is disposed, which consists of a ring 721 with ratchet pawls 722 as shifting elements in this embodiment as well. Here too, the ratchet pawls 722 are inclined on the side facing the crown gear 62b, and engage in the shifted state with several sawtooth recesses 622 distributed in the circumferential direction, on the inner front side of the crown gear 62b. On the other side of the ratchet pawl 722, to save space, a groove 724 is provided, in which the ratchet ring of the other crown-gear transmission is in the non-shifted state. The upper and lower part of the pawl 722 is set back slightly towards the crown gear 62b, and it forms a shifting tongue 723 recognizable in FIG. 16, and presenting a rounding or alternatively a bevel.

The shifting disk 21b contains, at defined places, passages 215 with corners 216. The corners 216 are provided either as in FIG. 16 with a bevel or alternatively with a radius. By rotation of the shifting disk 21b, the ratchet pawls 722 reach the passages 215. As a result, the entire ratchet ring 72b migrates under the force of a spring—not shown here—axially in the direction of the crown gear 62b. The ratchet pawl 722 is guided at all times axially in the corresponding recess 117 of the axle disk 11. In the non-shifted state, the ratchet pawl 722 is introduced into the recess 117 in such a way that the shifting disk 21b can slide past the ratchet pawl 722. In the shifted state, the ratchet pawl 722 protrudes through the passages 215 of the shifting disk 21b in the direction of the crown gear 62b beyond and over the shifting disk 21b, and it engages in the sawtooth recesses 622 of the crown gear 62b which are disposed in the peripheral direction. As a result, the locking of the crown gear 62b in one direction occurs. This state is represented in the detail sections in FIGS. 18 to 20. By means of the sawtooth recesses 622 of the crown gear 62b and the corresponding beveling of the ratchet pawl 722, a freewheeling occurs in the other rotational direction, because the ratchet pawl 722 is capable of being countersunk in the recess 117 of the axle disk 11. The rounding or bevelling or the corners 216 of the shifting disk passage 215, and the bevelling or rounding of the shifting tongue 723 of the ratchet pawl 722 have the effect that, when the shifting disk 21b continues to rotate, the ratchet pawls 722 are moved axially in the direction of the axle disk 11, until the ratchet pawls 722 are located completely behind the shifting disk 21b. As a result, the crown gear 62b is released.

The use of the ring 721 is not absolutely necessary. It merely guarantees a uniform load distribution in the case of the use of several ratchet pawls 722. The number of ratchet pawls 722 to be used is limited by the number of gears to be shifted and the available peripheral length. In the case of an 18-gear transmission based on a 9-gear transmission, one must ensure, for example, that, when 3 ratchet pawls per crown gear are used, 9 shifting processes can be carried out within 120°.

The tangential arrangement of the shifting disk passages 215 is determined by the shifting sequence, the position of the axle disks-recesses 117, and the number of ratchet pawls 722. The arrangement and shape of the shifting elements of FIG. 16, in the practical application, must be adapted in such a way that a freewheeling can be ruled out. The procedure is known to someone skilled in the art and not explained further.

For the shifting variant 2 as well, an axial shift possibility similar to that for the shifting variant 1 is conceivable.

Instead of the ratchet pawl rings described so far, it is possible, as before, to use ratchet pawls in the conventional design of a lever mounted rotatable about a pivot. In this case, the rotating axis of the pivot is in a plane which is perpendicular to the transmission shaft.

In FIG. 21, the schematic representation of a 7-gear bottom bracket transmission with partially direct gears is represented. Although the disks 11a and 11b, in the case of the bottom bracket transmission, are not connected as before to the transmission shaft, but to the bottom bracket shell, they continue to be referred to as axle disks because of the same function.

The drive torque is applied via the lever arms 111, the bottom bracket axis 110, and via the crown gear 3 connected non-rotatably to the bottom bracket axis, into the transmission. To provide different transmission ratios, the shifting clutches 71a, 72b or 71b and 72b connect the corresponding crown gears 61a, 62a or 61b, 62b non-rotatably to the axle disks 11a or 11b. The axle disks 11a and 11b are connected non-rotatably both to each other and also to the bottom bracket shell 100. The partially direct gears are implemented by the shifting clutches 70a and 70b. The latter connect the crown gears 61a or 61b to the pinion carriers 5a or 5b. As a result, the crown-gear transmissions a and/or b are skipped over in their gear ratio function, and the torque is transferred directly from the driving crown gear 3 to the coupling sheath 8 and/or from the coupling sheath 8 to the output crown gear 9. The crown gear 9 is connected non-rotatably to the chain leaf 91.

To implement an interruption-free torque transfer, it is necessary to provide the participating shifting clutches 71a, 72a, 71b, 72b as well as 70b with a freewheeling function, and to ensure that, during the shifting process, overlapping of the active shifting clutches occurs for each of the transmissions a and b.

FIG. 22 represents a simplified possible embodiment of the bottom bracket transmission. The numbering of the components corresponds largely to that of FIG. 21. In this embodiment, for the shifting clutches 71a, 72b or 72b and 73b, the conventional ratchet-pawl freewheels that can be lifted out are used. The shifting clutches 70a and 70b are in each case converted by axially shiftable balls 115 and an axially acting toothed disk freewheel 114, 114′. Both ratchet-pawl freewheels 71a and 72b of the crown transmission a are located between the crown gears 61a and 62a to be shifted. The situation is similar for the crown-gear transmission b.

The elements participating in the shifting, for the crown-gear transmission a, are represented in FIG. 23 in an exploded view. The operation of the ratchet-pawl freewheel is explained in reference to the crown gear 62a to be shifted. The shifting for the crown gear 61a, 61b and 62b occurs similarly.

The ratchet pawl 722 is mounted rotatable by means of a pivot 721 in the cylindrical breakthrough 111 of the axle disk 11a. The lever 723 of the ratchet pawl 722 protrudes through the passage 112 of the axle disk 11a into the groove 211 of the shifting disk 21, which is concentric to the bottom bracket axis. The groove 211 presents the recesses 217 at defined intervals. By rotation of the shifting disk 21 about the bottom bracket axis 110, the ratchet pawl lever 723 reaches the area of the recess 217. Thus, a spring—not shown here—can press the pawl 721 into the sawtooth recess 622 of the crown gear 62a. As a result, the crown gear 62a is connected in one direction non-rotatably to the axle disk 11a. Due to the operation of the ratchet-pawl freewheel, the crown gear 62a is free in the other rotational direction.

For the partially direct gears, the crown gear 61a is connected non-rotatable to the pinion carrier 5a. In the non partially direct gears, the balls 115 rest in the depression-like recesses 214 of the shifting disk 21 and in the bore 113 of the axle disk 113. Here, the toothed disks 114 and 114′ are separated from each other by means of a spring system not shown here. By rotation of the shifting disk 21, at the time of providing a partially direct gear, the ball 115 is moved out of the recesses 214 by the axial guidance of the bore 113 in the direction of the toothed disk 114. The toothed disk 114 is thus shifted against the force of a spring system in the direction of the toothed disk 114′, until the teeth of both toothed disks engage into each other. Due to an appropriate profiling, the toothed disk 114 is connected non-rotatably to the crown gear 61a. Only mutual axial shifting is possible. Similarly, the toothed disk 114′ is connected by a corresponding profiling non-rotatably to the pinion carrier 5a.

Instead of the described toothed disk freewheel, a ratchet-pawl freewheel which can be lifted out can naturally also be used. The latter must connect the freewheeling crown gear 62a non-rotatably to the connecting sleeve 8.

For the shift indexing, the recesses 118 of the axle disk 11a, which are distributed over the periphery, are used. In these recesses 118, a ball—not shown here—rests in the defined shifting positions, under the force of a spring.

If the use of the crown gears 62a and 62b and the associated shifting clutches 72a and 72b is omitted, and the same number of teeth is fixed for the remaining crown gears, one obtains a compact 3-gear transmission with the transmission ratios 0.5, 1 and 2. Conversely, if 3 shiftable crown gears (61a, 62a, 63a or 61b, 62b, 63b) per crown transmission are used, then, in the case of symmetric numbers of teeth, taking into consideration the partially direct gears, 4×4−3=13 gears are possible. Unfortunately, the generation of a reasonable gear stepping within the usual construction space is possible only by skipping over gears. Thus, for example, according to Table 8 one gets a largely geometrically stepped 11-gear transmission.

The above described transmissions are clutch transmissions, in which the crown-gear transmissions were coupled either via a common pinion carrier (FIG. 3 to FIG. 6, FIG. 21) or via connected crown gears (FIG. 7).

FIG. 24 shows a transmission in which the providing of 9 gears is ensured by a single minus transmission a. In the process, the drive-side crown gears 61a, 62a and 63a are connected, depending on the gear, to a driver 31. The previous pinion carriers 5a and 5b merge to form a common pinion carrier 5a. In contrast to the presented torque transmissions, in which the crown gears participating in the transmission are locked by the connection to the hub axle, in the case of the transmission of FIG. 24, the participating crown gears are in movement, which complicates a shifting of three concentrically disposed crown gears. To allow a simple shifting, one can exploit the circumstance that the crown gear with the smallest number of teeth presents the largest number of revolutions. For this purpose, the crown gears 61a, 62a and 63a are connected permanently via the freewheel clutches 71a, 72a and 73a to the driver 31. To provide the different transmissions, the freewheel 73a or the freewheels 73a and 72a are now lifted simultaneously from the shifting device 7a. The freewheel 71a works as automatic coupling and does not have to be shifted.

A combination of shifting clutch and automatic freewheel, as represented in FIG. 24 for shifting the drive crown gears, is also conceivable. Here, the shifting of the crown gears 62b and 63b works via the shifting clutch 7b while the freewheel clutch 71b works as automatic coupling. The shifting clutch 7b can occur, for example, via an axially movable coupling ring. The operation of this shifting device as well as the shifting devices for lifting out the freewheels are known in bicycle gear construction and not described further. The output of the crown-gear transmission of FIG. 24 is constructed symmetrically with the crown gears 61b, 62b and 63b to the drive side. Because, in the minus transmission a, a reversal of the rotational direction with respect to the drive 31 occurs, it is necessary to connect an additional minus transmission c downstream, which, as a result of renewed reversal of the rotational direction, ensures the identical rotational direction of the driver 31 and of the hub shell 10, unless a rotational direction reversal occurs already in the previous drive train. The output occurs via the crown gear 12 which is at the same time the drive of the transmission c. The output crown gear 13 of the transmission c is connected either directly or via a freewheel clutch to the hub shell 10. Via the ratio of the numbers of teeth of the crown gears 12 and 13, the total gear ratio can be adapted as needed. By means of an additional shifting device 15 and an additional crown gear 16, additional gears can theoretically be implemented. Since the construction space diameter is limited, there is, as a rule, overlap of the gears, because, in contrast to the output via the pinion carrier as in FIG. 3, no such large gear ratios are reached.

If a rotational direction reversal occurs already in the drive train before the transmission, then it is entirely possible to connect a crown-gear transmission c downstream, as in FIG. 4.

The drawback of the rotational direction reversal when using minus transmissions, as in FIG. 24, can be eliminated with a transmission arrangement according to FIG. 25. In this case, the pinions 4a of the pinion carriers 5a drive the pinions 4b of the pinion carriers 5b. As a result, the rotational direction of the crown gear 12 is the same as the rotational direction of the drive 31. Here, the steppings of the pinions 4a and 4b can be different.

To double the gears, an additional crown-gear transmission c can be connected downstream, which corresponds to the crown-gear transmission c of FIG. 4 in shape and function. Naturally, a planetary gearing can also be used in the transmissions of FIG. 24 and FIG. 25, instead of the crown-gear transmission c.

Moreover, a few of the numerous possible combinations of numbers of teeth are selected and represented in table form. The tables contain primarily the transmission characteristics, without the downstream-connected crown or planet gears to increase the gear number. This is explained for certain configurations separately at the end of the table. The combinations of numbers of teeth represented as examples correspond largely to the usual geometric stepping. The development is obtained from the interaction of pinion number of teeth, chain ring number of teeth, transmission, and wheel circumference. For an advantageous development, in the case of asymmetric numbers of teeth, the numbers of teeth of the crown-gear transmissions a, b can be exchanged.

TABLE 1

| | 18G, 4 pinions/pinion carriers, | | | | | | | | | |
|---|---|---|---|---|---|---|---|---|---|---|
| | asymmetric numbers of teeth | | | | | | | | Transmission | Progressive |
| Type | Transmission arrangement according to FIG. 3 | | | | | | | | ratio | ratio |
| Crown gear | 3 | 61a | 62a | 63a | 61b | 62b | 63b | 9 | | |
| Teeth crown gear | 32 | 32 | 52 | 80 | 44 | 64 | 80 | 65 | | |
| Teeth pinion | 17 | 17 | 15 | 14 | 15 | 17 | 17 | 17 | | |
| Gear 1 | | ◯ | | | | | ◯ | | 1.125 | |
| Gear 2 | | ◯ | | | | ◯ | | | 1.000 | 12.5 [%] |
| Gear 3 | | ◯ | | | ◯ | | | | 0.890 | 12.4 [%] |
| Gear 4 | | | ◯ | | | | ◯ | | 0.792 | 12.4 [%] |
| Gear 5 | | | ◯ | | | ◯ | | | 0.704 | 12.5 [%] |
| Gear 6 | | | ◯ | | ◯ | | | | 0.626 | 12.4 [%] |
| Gear 7 | | | | ◯ | | | ◯ | | 0.558 | 12.3 [%] |
| Gear 8 | | | | ◯ | | ◯ | | | 0.496 | 12.5 [%] |
| Gear 9 | | | | ◯ | ◯ | | | | 0.441 | 12.4 [%] |

| Total transmission 9G | | | 2.551 | |
|---|---|---|---|---|
| Crown-gear | 5 pinions/pinion carriers | | | G9/G10 |
| transmission c | | | | |
| Crown gear | 12 | 15 | 2.875 | 12.7 [%] |
| Teeth crown gear | 40 | 75 | | |
| Teeth pinion | = | = | | |
| Total transmission 18G | | | 7.334 | |

TABLE 2

| | 18G, 5 pinions/pinion carriers, | | | | | | | | | |
|---|---|---|---|---|---|---|---|---|---|---|
| | asymmetric numbers of teeth | | | | | | | | Transmission | Progressive |
| Type | Transmission arrangement according to FIG. 4 | | | | | | | | ratio | ratio |
| Crown gear | 3 | 61a | 62a | 63a | 61b | 62b | 63b | 9 | | |
| Teeth crown gear | 35 | 35 | 55 | 80 | 45 | 65 | 80 | 45 | | |
| Teeth pinion | 18 | 18 | 15 | 13 | 14 | 16 | 16 | 14 | | |
| Gear 1 | | ◯ | | | | | ◯ | | 1.125 | |
| Gear 2 | | ◯ | | | | ◯ | | | 1.132 | 12.9 [%] |
| Gear 3 | | ◯ | | | ◯ | | | | 1.000 | 13.2 [%] |
| Gear 4 | | | ◯ | | | | ◯ | | 0.886 | 12.9 [%] |
| Gear 5 | | | ◯ | | | ◯ | | | 0.785 | 12.9 [%] |
| Gear 6 | | | ◯ | | ◯ | | | | 0.693 | 13.2 [%] |
| Gear 7 | | | | ◯ | | | ◯ | | 0.614 | 13.0 [%] |
| Gear 8 | | | | ◯ | | ◯ | | | 0.544 | 12.9 [%] |
| Gear 9 | | | | ◯ | ◯ | | | | 0.480 | 13.2 [%] |

| Total transmission 9G | | | 2.660 | |
|---|---|---|---|---|
| Crown-gear | 5 pinions/pinion carriers | | | G9/G10 |
| transmission c | | | | |
| Crown gear | 12 | 15 | 3.000 | 12.8 [%] |
| Teeth crown gear | 40 | 80 | | |
| Teeth pinion | = | = | | |
| Total transmission 18G | | | 7.98 | |

TABLE 3

| | 9G, 5 pinions/pinion carriers, | | | | | | | | | |
|---|---|---|---|---|---|---|---|---|---|---|
| | asymmetric numbers of teeth | | | | | | | | Transmission | Progressive |
| Type | Transmission arrangement according to FIG. 3 | | | | | | | | ratio | ratio |
| Crown gear | 3 | 61a | 62a | 63a | 61b | 62b | 63b | 9 | | |
| Teeth crown gear | 35 | 35 | 75 | 110 | 70 | 90 | 110 | 70 | | |
| Teeth pinion | 18 | 18 | 17 | 13 | 17 | 16 | 15 | 17 | | |
| Gear 1 | | ◯ | | | | | ◯ | | 1.390 | |
| Gear 2 | | ◯ | | | | ◯ | | | 1.183 | 17.5 [%] |
| Gear 3 | | ◯ | | | ◯ | | | | 1 | 18.3 [%] |
| Gear 4 | | | ◯ | | | | ◯ | | 0.851 | 17.5 [%] |
| Gear 5 | | | ◯ | | | ◯ | | | 0.724 | 17.5 [%] |
| Gear 6 | | | ◯ | | ◯ | | | | 0.612 | 18.3 [%] |
| Gear 7 | | | | ◯ | | | ◯ | | 0.520 | 17.7 [%] |
| Gear 8 | | | | ◯ | | ◯ | | | 0.442 | 17.5 [%] |
| Gear 9 | | | | ◯ | ◯ | | | | 0.374 | 18.3 [%] |
| Total transmission 9G | | | | | | | | | 3.720 | |

TABLE 4

| | 14G, 5 pinions/pinion carriers, | | | | | | | | | |
|---|---|---|---|---|---|---|---|---|---|---|
| | symmetric numbers of teeth | | | | | | | | Transmission | Progressive |
| Type | Transmission arrangement according to FIG. 5 | | | | | | | | ratio | ratio |
| Crown gear | 3 | 61a | 62a | 63a | 61b | 62b | 63b | 9 | | |
| Teeth crown gear | 50 | 35 | 60 | 75 | 35 | 60 | 75 | 50 | | |
| Teeth pinion | 14 | 14 | 14 | 14 | 14 | 14 | 14 | 14 | | |
| Gear 1 | | ◯ | | | | | ◯ | | 1.471 | |
| Gear 2 | | ◯ | | | | ◯ | | | 1.294 | 13.6 [%] |
| Gear 3 | | | ◯ | | | | ◯ | | 1.136 | 13.9 [%] |
| Gear 4 | | | ◯ | | | ◯ | | | 1 | 13.6 [%] |
| Gear 5 | | | | ◯ | | ◯ | | | 0.880 | 13.6 [%] |
| Gear 6 | | | ◯ | | ◯ | | | | 0.773 | 13.9 [%] |
| Gear 7 | | | | ◯ | ◯ | | | | 0.680 | 13.6 [%] |

| Total transmission 7G | | | 2.1626 | |
|---|---|---|---|---|
| Crown-gear | 5 pinions/pinion carriers | | | G7/G8 |
| transmission c | | | | |
| Crown gear | 12 | 15 | 2.461 | 13.8 [%] |
| Teeth Crown gear | 55 | 75 | | |
| Teeth Pinion | 15 | 14 | | |
| Total transmission 14G | | | 5.322 | |

By simply exchanging the drive and output crown gear from Table 4, one obtains transmissions with a largely constant progressive ratio according to Table 5.

TABLE 5

| Teeth crown | | |
|---|---|---|
| gear 3; | Total transmission ratio | Progressive ratio |
| 9 | | |
| 60 | 2.019 | min = 12.3 [%]; max = 12.5 [%] |
| 55 | 2.086 | min = max = 13.0 [%] |
| 45 | 2.250 | min = 14.3 [%]; max = 14.8 [%] |
| 40 | 2.351 | min = 15.0 [%]; max = 15.9 [%] |
| 35 | 2.469 | min = 15.8 [%]; max = 17.2 [%] |

TABLE 6

| | 7G, 5 pinions/pinion carriers, | | | | | | | |
|---|---|---|---|---|---|---|---|---|
| | symmetric, partially direct gears | | | | | | | |
| | Transmission arrangement | | | | | | | |
| | according to FIG. 5, | | | | | | Transmission | Progressive |
| Type | without crown-gear transmission c | | | | | | ratio | ratio |
| Crown gear | 3 | 61a | 62a | 61b | 62b | 9 | | |
| Teeth crown gear | 85 | 35 | 50 | 35 | 50 | 85 | | |
| Teeth pinion | 13 | 18 | 16 | 18 | 16 | 13 | | |
| Gear 1 | | direct | | | ◯ | | 1.478 | |
| Gear 2 | | direct | | ◯ | | | 1.297 | 13.9 [%] |
| Gear 3 | | ◯ | | | ◯ | | 1.139 | 13.9 [%] |
| Gear 4 | | direct | | direct | | | 1 | 13.9 [%] |
| Gear 5 | | | ◯ | ◯ | | | 0.878 | 13.9 [%] |

| | | | | | |
|---|---|---|---|---|---|
| Gear 6 | ◯ | | direct | 0.771 | 13.9 [%] |
| Gear 7 | | ◯ | direct | 0.677 | 13.9 [%] |
| Total transmission 7G | | | | 2.183 | |

TABLE 7

| | 7G, 5 pinions/pinion carriers, | | | | | | | |
|---|---|---|---|---|---|---|---|---|
| | symmetric, partially direct gears | | | | | | | |
| | Transmission arrangement | | | | | | Transmission | Progressive |
| Type | according to FIG. 21 | | | | | | ratio | ratio |
| Crown gear | 3 | 61a | 62a | 61b | 62b | 9 | | |
| Teeth crown gear | 65 | 40 | 70 | 40 | 70 | 65 | | |
| Teeth pinion | = | = | = | = | = | = | | |
| Gear 1 | | | ◯ | direct | | | 2.077 | |
| Gear 2 | | ◯ | | direct | | | 1.615 | 28.6 [%] |
| Gear 3 | | | ◯ | ◯ | | | 1.286 | 25.6 [%] |
| Gear 4 | | direct | | direct | | | 1 | 28.6 [%] |
| Gear 5 | | ◯ | | | ◯ | | 0.778 | 28.6 [%] |

| | | | | | |
|---|---|---|---|---|---|
| Gear 6 | direct | ◯ | | 0.619 | 25.6 [%] |
| Gear 7 | direct | | ◯ | 0.481 | 28.6 [%] |
| Total transmission 7G | | | | 4.314 | |

TABLE 8

| | 11G, 5 pinions/pinion carriers, | | | | | | | | | |
|---|---|---|---|---|---|---|---|---|---|---|
| | symmetric, partially direct gears | | | | | | | | Transmission | Progressive |
| Type | Transmission arrangement according to FIG. 21 | | | | | | | | ratio | ratio |
| Crown gear | 3 | 61a | 62a | 63a | 61b | 62b | 63b | 9 | | |
| Teeth crown gear | 60 | 40 | 60 | 80 | 40 | 60 | 80 | 60 | | |
| Teeth pinion | = | = | = | = | = | = | = | = | | |
| 1st Gear 1 | | | | ◯ | | direct | | | 2.333 | |
| 2nd Gear 2 | | | ◯ | | | direct | | | 2.000 | 16.7 [%] |
| 3rd Gear 3 | | ◯ | | | | direct | | | 1.667 | 20.0 [%] |
| 4th Gear 4 | | | | ◯ | ◯ | | | | 1.400 | 19.0 [%] |
| 5th | | | ◯ | | ◯ | | | | 1.200 | |
| 6th Gear 5 | | | | ◯ | | ◯ | | | 1.167 | 20.0 [%] |
| 7th Gear 6 | | | direct | | | direct | | | 1 | 16.7 [%] |
| 8th Gear 7 | | | ◯ | | | | ◯ | | 0.857 | 16.7 [%] |
| 9th | | ◯ | | | | ◯ | | | 0.833 | |
| 10th Gear 8 | | ◯ | | | | | ◯ | | 0.714 | 20.0 [%] |

| | | | | | | |
|---|---|---|---|---|---|---|
| 11th Gear 9 | direct | ◯ | | | 0.600 | 19.0 [%] |
| 12th Gear 10 | direct | | ◯ | | 0.500 | 20.0 [%] |
| 13th Gear 11 | direct | | | ◯ | 0.429 | 16.7 [%] |
| Total transmission 11G | | | | | 5.445 | |

TABLE 9

| | 13G, 5 pinions/pinion carriers | | | | | | | |
|---|---|---|---|---|---|---|---|---|
| | Transmission arrangement | | | | | | Transmission | Progressive |
| Type | according to FIG. 24 | | | | | | ratio | ratio |
| Crown gear | 61a | 62a | 63a | 61b | 62b | 63b | | |
| Teeth crown gear | 65 | 75 | 80 | 40 | 60 | 85 | | |
| Teeth pinion | 15 | 15 | 14 | 15 | 15 | 14 | | |
| Gear 1 | ◯ | | | | | ◯ | 1.401 | |
| Gear 2 | | ◯ | | | | ◯ | 1.214 | 15.4 [%] |
| Gear 3 | | | ◯ | | | ◯ | 1.062 | 14.3 [%] |
| Gear 4 | ◯ | | | | ◯ | | 0.923 | 15.1 [%] |
| Gear 5 | | ◯ | | | ◯ | | 0.800 | 15.4 [%] |
| Gear 6 | | | ◯ | | ◯ | | 0.700 | 14.3 [%] |
| Gear 7 | ◯ | | | ◯ | | | 0.615 | 13.8 [%] |
| Gear 8 | | ◯ | | ◯ | | | 0.533 | 15.4 [%] |
| Gear 9 | | | ◯ | ◯ | | | 0.467 | 14.3 [%] |

| Total transmission 9G | | | 3.002 | |
|---|---|---|---|---|
| Crown-gear transmission c | G9/G10 | | | |
| Crown gear | 15 | 12 | 1.615 | 15.3[%] |
| Teeth Crown gear | 70 | 40 | | |
| Teeth Pinion | 14 | 14 | | |
| Total transmission 13G | | | 5.250 | |

TABLE 10

| | 9G, 5 pinions/pinion carriers, | | | | | | | |
|---|---|---|---|---|---|---|---|---|
| | Transmission arrangement | | | | | | | |
| | according to FIG. 25, | | | | | | Transmission | Progressive |
| Type | without crown-gear transmission c | | | | | | ratio | ratio |
| Crown gear | 61a | 62a | 63a | 61b | 62b | 63b | | |
| Teeth crown gear | 35 | 50 | 60 | 35 | 60 | 85 | | |
| Teeth pinion | 15 | 18 | 18 | 18 | 15 | 15 | | |
| Gear 1 | ◯ | | | | | ◯ | 2.429 | |
| Gear 2 | | ◯ | | | | ◯ | 2.040 | 19.0 [%] |
| Gear 3 | | | ◯ | | | ◯ | 1.700 | 20.0 [%] |
| Gear 4 | ◯ | | | | ◯ | | 1.429 | 19.0 [%] |
| Gear 5 | | ◯ | | | ◯ | | 1.200 | 19.0 [%] |
| Gear 6 | | | ◯ | | ◯ | | 1.000 | 20.0 [%] |
| Gear 7 | ◯ | | | ◯ | | | 0.833 | 20.0 [%] |
| Gear 8 | | ◯ | | ◯ | | | 0.700 | 19.0 [%] |
| Gear 9 | | | ◯ | ◯ | | | 0.583 | 20.0 [%] |
| Total transmission 9G | | | | | | | 4.166 | |

1-20. (canceled)

21. Multi-gear transmission for bicycles, comprising at least two crown-gear transmissions (a, b) for providing different transmission ratios, with at least two crown gears (3, 9, 61a, 62a, 63a, 61b, 62b, 63b), a shifting device (2; 2a, 2b) for selectively connecting the crown gears (3, 9, 61a, 62a, 63a, 61b, 62b, 63b) to fixed and/or rotating drive elements (1, 11, 11a, 11b, 12, 31) and a plurality of pinions (4a, 4b) disposed between the crown gears (3, 9, 61a, 62a, 63a, 61b, 62b, 62c), each of said pinions being mounted on a pinion carrier (5a, 5b) rotatable about axes (51a, 51b) that are perpendicular to the rotating axis of the crown gears (3, 9, 61a, 62a, 63a, 61b, 62b, 63b) and being engaged with the crown gears (3, 9, 61a, 62a, 63a, 61b, 62b, 63b), wherein the two crown-gear transmissions (a, b) present a common rotating axis (50), and each pinion (4a, 4b) of the pinion carrier (5a, 5b) is in permanent engagement with at least two crown gears (3, 9, 61a, 62a, 63a, 61b, 62b, 63b).

22. Multi-gear transmission according to claim 21, wherein each crown-gear transmission (a, b) contains three crown gears (61a, 62a, 63a, 61b, 62b, 63b) which are engaged permanently with the associated pinions (4a, 4b).

23. Multi-gear transmission according to claim 21, wherein each crown-gear transmission (a, b) contains at least three pinions (4a, 4b)—disposed in the shape of a star about the rotating axis (50)—with several pinion stages (41a, 42a, 43a, 41b, 42b, 43b).

24. Multi-gear transmission according to one of claims 21, wherein the pinion carriers (5a, 5b) of the first and the second crown-gear transmission (a, b) are non-rotatably connected to each other.

25. Multi-gear transmission according to claim 24, wherein the pinion carriers (5a, 5b) of the first and the second crown-gear transmission (a, b) are non-rotatably connected to each other by a connecting sleeve (8).

26. Multi-gear transmission according to claim 21, wherein a crown gear (63a) of the first crown-gear transmission (a) and a crown gear (63b) of the second crown-gear transmission (b) are non-rotatably connected to each other by a connecting sleeve (8).

27. Multi-gear transmission according to claim 26, wherein the two crown gears (63a, 63b) which are non-rotatably connected to each other are designed to form a single piece with the connecting sleeve (8).

28. Multi-gear transmission according to claim 21, wherein a third crown-gear transmission (c) with two crown gears (12, 13) and at least one pinion (4c) disposed on a pinion carrier (5c) is disposed downstream of the second crown-gear transmission (b).

29. Multi-gear transmission according to claim 21, wherein at least one crown-gear transmission (a, b) contains a shifting clutch (15), by means of which either the two crown gears (3, 9) of the respective crown-gear transmission (a, b) or the pinion carrier (5a, 5b, 5c) can be coupled to the associated crown gear (3, 9, 61a, 61b).

30. Multi-gear transmission according to claim 28, wherein the crown gear of the third crown-gear transmission (c) is connected via a freewheel (14) to a transmission shaft (1) or a bottom bracket shell (100).

31. Multi-gear transmission according to claim 21, wherein the shifting device (2; 2a, 2b) contains an axle disk (11, 11a, 11b) which is concentric to the rotating axis (50), and a shifting disk (21, 21a, 21b) which is concentric to the rotating axis (50), where the axle disk (11, 11a, 11b) is non-rotatably mounted, and the shifting disk (21, 21a, 21b) is mounted rotatable about the rotating axis (50).

32. Multi-gear transmission according to claim 31, wherein the axle disk (11, 11a, 11b) and the shifting disk (21, 21a, 21b) present at least concentrically disposed grooves (211, 116) and passages (111, 112, 113, 117, 118, 212, 215, 217) or recesses (214) for moving shift pins (115) or ratchet pawls (722).

33. Multi-gear transmission according to claim 32, wherein the ratchet pawls (722) are disposed in a shifting disk (21) which is connected rigidly to the shifting sleeve (2), and in passages (111) of an axle disk (11b) which is connected rigidly to a transmission shaft (1).

34. Multi-gear transmission according to claim 32, wherein the ratchet pawls (722) are disposed in an axle disk (11) which is connected rigidly to a transmission shaft (1), and in passages (215) of a shifting disk (21b) which is connected rigidly to the shifting sleeve (2b).

35. Multi-gear transmission according to claim 32, wherein the ratchet pawls (722) are disposed in a ratchet ring (721).

36. Multi-gear transmission according to claim 32, wherein the ratchet pawls (722) act as ratchet freewheel axially in the direction of the rotating axis (50).

37. Multi-gear transmission according to claim 32, wherein the ratchet pawls (722) act as ratchet freewheel radially perpendicular to the direction of the rotating axis (50).

38. Multi-gear transmission according to claim 21, wherein it is integrated in a hub shell (10) or a bottom bracket shell (100).

39. Multi-gear transmission according to claim 21, wherein the pinions (4a) of the pinion carrier (5a) are engaged with the pinions (4b) of the pinion carrier (5b).

40. Multi-gear transmission for bicycles, comprising at least two crown-gear transmissions (a, b) for providing different transmission ratios, each with at least two crown gears (61a, 62a, 63a, 61b, 62b, 63b), a shifting device (7a) for selectively connecting the crown gears (61a, 62a, 63a, 61b, 62b, 63b) with fixed and/or rotating drive elements (1, 31) and a plurality of pinions (4a) disposed between the crown gears (3, 9, 61a, 62a, 63a, 61b, 62b, 63b), said pinions being mounted on a common pinion carrier (51a) rotatable about axes that are perpendicular to the rotating axis of the gears (61a, 62a, 63a, 61b, 62b, 63b) and engaged with the crown gears (61a, 62a, 63a, 61b, 62b, 63b), wherein the two crown-gear transmissions (a, b) present a common rotating axis (50), and each pinion (4a) of the pinion carrier (5a) is engaged permanently with at least two crown gears (61a, 62a, 63a, 61b, 62b, 63b).
